(19) United States
(12) Patent Application Publication
(10) Pub. No.: US 2008/0013051 A1
(43) Pub. Date: Jan. 17, 2008

(54) POLARIZING BEAM SPLITTERS INCORPORATING REFLECTIVE AND ABSORPTIVE POLARIZERS AND IMAGE DISPLAY SYSTEMS THEREOF

(75) Inventors: Alexander L. Glinski, Cincinnati, OH (US); John E. Duncan, Amelia, OH (US); Charles L. Bruzzone, Woodbury, MN (US); Audrey A. Sherman, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/457,599

(22) Filed: Jul. 14, 2006

(51) Int. Cl. G03B 21/14

(52) U.S. Cl. 353/20

(57) ABSTRACT

An image display system including an illumination source configured to emit a light beam, a polarizing beam splitter, and an image-forming device. The polarizing beam splitter includes a reflective polarizer and an absorptive polarizer disposed adjacent to the reflective polarizer, where the absorptive polarizer is configured to receive a first portion of the light beam that has transmitted through the reflective polarizer. The image-forming device is disposed to receive a second portion of the light beam that has been reflected by the reflective polarizer.

### BACKGROUND OF THE INVENTION

The present disclosure relates to image display systems that incorporate polarization-separation devices. In particular, the present disclosure relates to image display systems that incorporate polarizing beam splitters (PBSs) having reflective and absorptive polarizers.

Image display systems incorporating PBSs are used to form images on viewing screens, such as projection displays. A typical image display system incorporates an illumination source that is arranged so that light rays from the illumination source reflect off of an image-forming device (i.e., an imager) that contains the desired image to be projected. The system folds the light rays such that the light rays from the illumination source and the light rays of the projected image share the same physical space between a PBS and the imager.

PBSs typically operate in high-angle beam cones, using low F/# illumination systems to increase illumination on a viewing screen, where “F/#” refers to a ratio of the focal length of a lens to the diameter of the lens. However, low F/# illumination systems typically have light rays intersecting PBS polarizers at high incident angles to the normal of the PBS polarizers. This causes residual rays of light, particularly in the red-wavelength spectrum, to leak through the PBS polarizer. This light leak correspondingly results in contrast ratio reductions. One common technique to correct this issue involves placing an absorptive polarizer adjacent the exit of the PBS to absorb the leaked light. However, external polarizers are sensitive to alignment orientations and increase the manufacturing complexity of the image display system.

### BRIEF SUMMARY OF THE INVENTION

The present invention relates to an image display system that includes an illumination source configured to emit a light beam, a PBS, and an image-forming device. The PBS includes a reflective polarizer and an absorptive polarizer disposed adjacent the reflective polarizer, where the absorptive polarizer is configured to receive a first portion of the light beam that has transmitted through the reflective polarizer. The image-forming device is disposed to receive a second portion of the light beam that has been reflected by the reflective polarizer.

### BRIEF DESCRIPTION OF THE DRAWINGS

FIG. 1 is a schematic illustration of an image display system of the present disclosure.

FIG. 2A is a micrograph of a display pupil of a comparative image display system, showing a red light leak.

FIG. 2B is a micrograph of a display pupil of an image display system of the present disclosure.

FIG. 3 is a graph representing contrast ratio versus light-wavelength spectrum for exemplary image display systems of the present disclosure and comparative image display systems.

FIG. 4 is a graph representing contrast ratio, which is photopically weighted, versus polarizer incident angles for exemplary image display systems of the present disclosure and comparative image display systems.

FIG. 5 is a graph representing contrast ratio versus light-wavelength spectrum for exemplary image display systems of the present disclosure and comparative image display systems.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

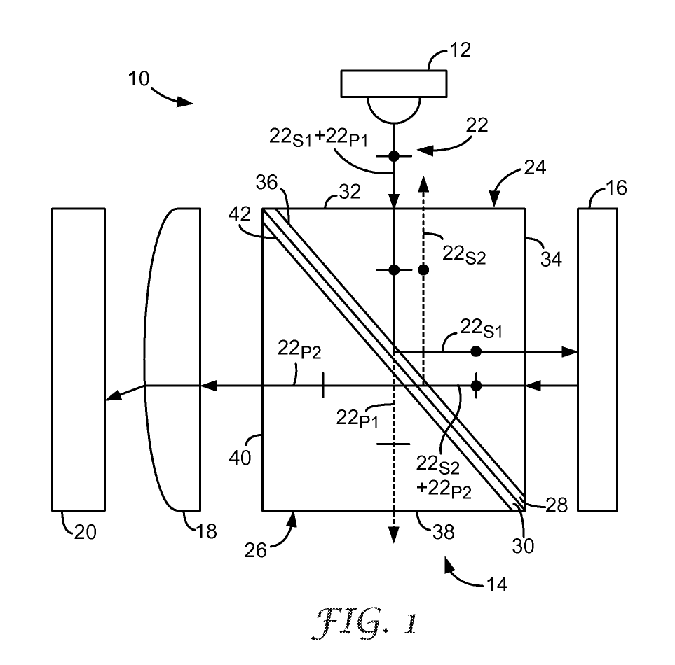

FIG. 1 is a schematic illustration of image display system 10 of the present disclosure, which may be used in a variety of display devices, such as mini-projection displays, head-mounted displays, virtual viewers, electronic viewfinders, heads-up displays, optical computing, optical correlation, and other optical viewing systems. System 10 includes illumination source 12, PBS 14, imager 16, projection lens 18, and display screen 20. As discussed below, PBS 14 is configured to reduce the risk of light leaks, thereby enhancing the contrast ratio of the resulting image.

Illumination source 12 is a light-emitting diode (LED) light source configured to emit light beam 22 toward PBS 14. While shown in FIG. 1 as a single LED, illumination source may alternatively include a plurality of LEDs to emit light beam 22 or other light sources (e.g., laser diodes, incandescent bulbs, and arc lamps). In one embodiment, illumination source 12 includes LEDs of different colors (e.g., red, green, and blue) and a color combiner (e.g., an x-cube configuration color combiner), where the color combiner combines received colored light beams and directs the resulting light beam 22 toward PBS 14. Illumination source 12 may also include a ball lens (not shown), a gradium-type microlens (not shown), and/or a graded index (GRIN) lens (not shown) disposed around the LED for further capturing and directing light beam 22 toward PBS 14.

For ease of discussion, light beam 22 is illustrated in FIG. 1 as a single light ray. However, one skilled in the art will recognize that light beam 22 is emitted toward PBS 14 as a light cone of multiple light rays. Light beam 22 is emitted from illumination source 12 in an unpolarized state. As such, light beam 22 includes light rays in both the s-polarized state (light rays 22_{S1}) and the p-polarized state (light rays 22_{P1}). In accordance with conventional symbols, light rays in the s-polarization state are labeled with a dot “•” (representing a first orthogonal electric field segment that extends out of the plane of the paper, orthogonal to the view of FIG. 1), and light beams in the p-polarization state are labeled with a symbol “|” (representing a second orthogonal electric field segment with the electric field vector of the light polarized in the plane of the paper.

PBS 14 includes input prism 24, output prism 26, reflective polarizer 28, and absorptive polarizer 30. Input prism 24 and output prism 26 are low-birefringence prisms (i.e., polarizer covers) disposed adjacent each other on opposing sides of reflective polarizer 28 and absorptive polarizer 30. Input prism 24 and output prism 26 may be constructed from any light-transmissive material having a suitable refractive index to achieve the desired purpose of PBS 14. A “light-transmissive” material is one that allows at least a portion of incident light to transmit through the material. Suitable materials for use as prisms include ceramics, glass, and polymers.

Input prism 24 includes outer surfaces 32 and 34, and incident surface 36. Similarly, output prism 26 includes outer surfaces 38 and 40, and incident surface 42. While input prism 24 and output prism 26 are shown as triangular prisms, one or both of input prism 24 and output prism 26 may alternatively function as a polarizer cover having a variety of different geometries. For example, one or both of input prism 24 and output prism 26 may have four or more lateral surfaces as design and optic requirements may necessitate. As shown, reflective polarizer 28 and absorptive polarizer 30 are disposed adjacent each other such that reflective polarizer 28 faces incident surface 36 of input prism 24 and absorptive polarizer 30 faces incident surface 42 of output prism 26.

Reflective polarizer 28 splits the rays of light beam 22 received from illumination source 12 into reflected polarization components (s-polarized light rays) and transmitted polarization components (p-polarized light rays). In alternative embodiments, system 10 also includes one or more reflective or absorptive pre-polarizers to at least partially pre-polarize light beam 22 prior to entering PBS 14. In these embodiments, the one or more pre-polarizers transmit s-polarized light rays and at least partially reflect or absorb p-polarized light rays.

Reflective polarizer 28 can be any reflective polarizer known to those of skill in the art, such as a linear reflective polarizer or a circular reflective polarizer. Specific examples of linear reflective polarizers suitable for use in the embodiments of the present disclosure include wire-grid polarizers (e.g., with low index materials, such as air, adjacent to the wire grids, as disclosed in Magarill et al., U.S. Pat. No. 6,719,426, the disclosure of which is incorporated by reference herein to the extent it is not inconsistent with the present disclosure), dielectric thin film coatings (e.g., MacNeille PBSs), polymer blend polarizing films, fiberglass composite polarizers, and birefringent-polymer multi-layer optical films (MOF). Specific examples of circular reflective polarizing films suitable for use in the embodiments of the present disclosure include cholesteric polarizers, which can be used with a ¼-wave plate disposed between reflective polarizer 28 and absorptive polarizer 30.

Examples of suitable fiberglass composite polarizers include those disclosed in co-owned U.S. patent application Ser. No. 11/068,158, which was filed on Feb. 28, 2005, the disclosure of which is incorporated by reference herein to the extent it is not inconsistent with the present disclosure. Examples of suitable birefringent-polymer multi-layer optical films include those manufactured by 3M Company, St. Paul, Minn., and described in Jonza et al., U.S. Pat. No. 5,882,774; Weber et al., U.S. Pat. No. 6,609,795; and Magarill et al., U.S. Pat. No. 6,719,426, the disclosures of which are incorporated by reference herein. Additional examples of suitable birefringent-polymer multi-layer optical films include those manufactured under the trade designation “VIKUITI” advanced polarizing films (APF) from 3M Company.

In some exemplary embodiments, reflective polarizer 28 may include at least a first layer and a second layer, and, preferably, pluralities of interleaved first layers and second layers, where the polymeric materials of the first and second layer are different. In one embodiment of the present disclosure, reflective polarizer 28 may include a multi-layer stack of alternating layers of different polymer materials, as disclosed in Weber et al., U.S. Pat. No. 6,609,795, the disclosure of which is incorporated by reference herein to the extent it is not inconsistent with the present disclosure.

Suitable polymeric linear reflective polarizing films are typically characterized by a large refractive index difference between different materials along a first direction in the plane of the film (Δnₓ) and a small refractive index difference between different materials along a second direction in the plane of the film (Δn_{y}), orthogonal to the first direction. In some exemplary embodiments, reflective polarizing films are also characterized by small refractive index differences between the different polymeric materials along the thickness direction of the film (Δn_{z}) (e.g., between the first and second layers of different polymeric materials). In general, the mismatch in index between the y indices of the two materials should be small for high transmission in the pass state while maintaining high reflectance in the block state. The allowed magnitude of the y-index mismatch and the z-index mismatch (i.e., the non-stretched directions) can each be described relative to the x-index mismatch (i.e., the stretched direction) because the latter value suggests the number of layers used in the polarizer thin film stack to achieve a desired degree of polarization.

The total reflectivity of a thin film stack is correlated with the index mismatch Δn and the number of layers in the stack N (i.e., the product (Δn)²×N correlates to the reflectivity of a stack). For example, to provide a film of the same reflectivity but with half the number of layers requires √2 times the index differential between layers, and so forth. The absolute value of the ratio Δn_{y}/Δnₓ is the relevant parameter that is desirably controlled, where Δn_{y}=n_{y1}−n_{y2} and Δnₓ=nₓ₁−nₓ₂ for first and second materials in an optical repeat unit as described herein. Examples of suitable absolute values of the ratio of Δn_{y}/Δnₓ include about 0.2 or less, about 0.1 or less, more desirably about 0.05 or less, and even more desirably about 0.02 or less. Preferably, the ratio Δn_{y}/Δnₓ is maintained below the desired limit over the entire wavelength range of interest (e.g., over the visible spectrum). Suitable values for Δnₓ range from about 0.06 or higher, about 0.09 or higher, more preferably about 0.12 or higher, and even more preferably about 0.15 or higher, or even about 0.20 or higher.

The allowed magnitude of the z-index mismatch, like the y-index mismatch, can also be described relative to the x-index mismatch. The absolute value of the ratio of Δn_{z}/Δnₓ is the relevant parameter that is desirably controlled, where Δn_{z}=n_{z1}−n_{z2} and Δnₓ=nₓ₁−nₓ₂ for first and second materials in an optical repeat unit as described herein. Examples of suitable absolute values of the ratio of Δn_{z}/Δnₓ include about 0.2 or less, about 0.1 or less, more desirably about 0.05 or less, and even more desirably about 0.02 or less. Preferably, the ratio Δn_{z}/Δnₓ is maintained below the desired limit over the entire wavelength range of interest (e.g., over the visible spectrum).

Absorptive polarizer 30 is configured to receive the light rays of light beam 22 that transmit through reflective polarizer 28, and is also configured to absorb light rays that are in the s-polarization state. As such, absorptive polarizer 30 functions as a clean-up polarizer that absorbs s-polarized light rays that leak through reflective polarizer 28, while allowing p-polarized light rays to transmit through. Absorptive polarizer 30 can be any dichroic polarizing film known to those of skill in the art, such as those disclosed in Kausch et al., U.S. Pat. No. 6,610,356, and Ouderkirk et al., U.S. Pat. No. 6,096,375, the disclosures of which are incorporated by reference herein.

In the arrangement shown in FIG. 1, the block axis of reflective polarizer 28 is desirably aligned as accurately as possible with the block axis of the absorptive polarizer 30, thereby providing acceptable performance for a particular application (e.g., a brightness enhancement polarizer). Increased misalignment of the block axes diminishes the gain produced by securing reflective polarizer 28 and absorptive polarizer 30 together between input prism 24 and output prism 26, thereby reducing the efficiency of PBS 14 for some display applications. For example, for a brightness enhancement polarizer, the angle between the block axes of reflective polarizer 28 and absorptive polarizer 30 should be less than about +/−3°, and even more preferably less than about +/−1°.

In one embodiment, absorptive polarizer 30 is configured to block spectrum bands that reflective polarizer 28 is less suitable for blocking (and vice versa). For example, absorptive polarizer 30 may be configured to absorb red-wavelength light rays (i.e., from about 600 nanometers to about 700 nanometers) along a block axis of absorbing polarizer 30. As discussed below, for some multi-layer optical films, red-wavelength light rays that have high incident angles to the normal of reflective polarizer 28 leak through reflective polarizer 28, rather than being reflected. This reduces the contrast ratio of the resulting image in the red-wavelength spectrum. In another embodiment, absorptive polarizer 30 is configured to absorb orange-wavelength and red-wavelength light rays (i.e., from about 580 nanometers to about 700 nanometers) along a block axis of absorbing polarizer 30. These embodiments allow absorptive polarizer 30 to block red/orange-wavelength light rays, which have the highest transmission percentages, while also preserving the transmission levels of the image-containing light rays.

PBS 14 is assembled by securing reflective polarizer 28 and absorptive polarizer 30 together such that the block axes of reflective polarizer 28 and absorptive polarizer 30 are aligned as accurately as possible. Securing reflective polarizer 28 and absorptive polarizer 30 together reduces the risk of misaligning the block axes of reflective polarizer 28 and absorptive polarizer 30 during the assembly of system 10. The combined reflective polarizer 28/absorptive polarizer 30 is then placed between incident surfaces 36 and 42 of input prism 24 and output prism 26, respectively. Input prism 24 and output prism 26 are then secured together, which makes the resulting PBS 14 optically efficient and mechanically robust for the manufacturing and use of system 10. In alternative embodiments, either or both of input prism 24 and output prism 26 may be omitted. In these embodiments, the alignment of the block axes of reflective polarizer 28 and absorptive polarizer 30 remain preserved by securing polarizer 28 and absorptive polarizer 30 together. An absorptive polarizer 30 may be secured to a reflective polarizer 28 by lamination, co-extrusion of the two elements, coating the absorptive polarizer on the reflective polarizer, or by any other suitable means known to those of skill in the art.

Imager 16 is a polarization-rotating component, such as a liquid crystal on silicon (LCoS) imager (e.g., a ferroelectric LCoS), which is disposed adjacent outer surface 34 of input prism 24. Imager 16 reflects and rotates the polarization of the rays of light beam 22 based on whether the pixels of imager 16 are “on” or “off”. The individual rays of light beam 22 that contact the “off” pixels of imager 16 reflect off imager 16 with their polarizations unchanged (i.e., retain s-polarization). In contrast, the individual rays of light beam 22 that contact the “on” pixels of imager 16 reflect off imager 16 with their polarizations rotated (i.e., rotated from s-polarization to p-polarization). As a result, imager 16 may rotate the polarization of the individual rays of light beam 22 based on pixel settings, which are controlled to create a desired projected image.

Projection lens 18 is disposed adjacent outer surface 40 of output prism 26, such that it collects the rays of light beam 22 received from PBS 14 for transmission to display screen 20. While only illustrated with a single projection lens, system 10 may include additional imaging optics or no projection optics, as needed. Display screen 20 is a viewing screen that a user of system 10 can use to observe the image formed by light beam 22.

During use of system 10, illumination source 12 emits light beam 22 toward PBS 14, where light beam 22 includes light rays 22_{S1} (i.e., the s-polarized rays of light beam 22) and light rays 22_{P1} (i.e., the p-polarized rays of light beam 22). Light beam 22 enters PBS 14 by passing through outer surface 32, and traveling toward reflective polarizer 28. Prior to reaching reflective polarizer 28, light beam 22 passes through incident surface 36 of input prism 24. Reflective polarizer 28 then reflects light rays 22_{S1} (s-polarized light rays) toward outer surface 34 of input prism 24, and transmits light rays 22_{P1} (p-polarized light rays) toward absorptive polarizer 30. A residual portion of light rays 22_{S1} may also transmit through reflective polarizer 28 due to design limitations, haze, or manufacturing variations in reflective polarizer 28.

As discussed above, absorptive polarizer 30 blocks s-polarized light rays and transmits p-polarized light rays. Therefore, absorptive polarizer 30 intercepts and absorbs the residual portion of light rays 22_{S1}, and transmits light rays 22_{P1} into output prism 26. Light rays 22_{P1} enter output prism 26 through incident surface 42 and travel toward outer surface 38. Light rays 22_{P1} then exit output prism 26 through outer surface 38 and may be discarded.

Light rays 22_{S1} exit PBS 14 by passing through outer surface 34 of input prism 24. After exiting input prism 24, light rays 22_{S1} contact and reflect off imager 16. The individual light rays 22_{S1} that contact pixels of imager 16 in the “off” state retain their s-polarization upon reflection. However, the individual light rays 22_{S1} that contact pixels of imager 16 in the “on” state have their polarizations rotated from s-polarization to p-polarization upon reflection. As a result, the reflected light beam 22 includes a new series of s-polarized light rays (light rays 22_{S2}) and p-polarized light rays (light rays 22_{P2}), where light rays 22_{P2} are image-containing light rays and light rays 22_{S2} are non-image-containing light rays.

Light rays 22_{S2} and 22_{P2} reflected from imager 16 are directed back toward input prism 24, and re-enter input prism 24 through outer surface 34. Light rays 22_{S2} and 22_{P2} then pass through incident surface 36 of input prism 24 and contact reflective polarizer 28. Reflective polarizer 28 then reflects light rays 22_{S2} (s-polarized light rays) toward illumination source 12, and transmits light rays 22_{P2} (p-polarized light rays) toward absorptive polarizer 30.

After transmitting through absorptive polarizer 30, light rays 22_{P2} (i.e., the image-containing light rays) enter output prism 26 through incident surface 42. Light rays 22_{P2} then exit output prism 26 through outer surface 40, and travel toward projection lens 18. Projection lens 18 then collects light rays 22_{P2} and directs the light rays 22_{P2} toward display screen 20 with the desired projected image.

Ideally, with this arrangement, reflective polarizer 28 of PBS 14 would cleanly separate the image-containing light rays (i.e., light rays 22_{P2}) from the non-image-containing light rays (i.e., light rays 22_{S2}), thereby providing an image having a high contrast ratio. However, individual light rays 22_{S2} that transmit toward reflective polarizer 28 at high incident angles to the normal of reflective polarizer 28 leak (i.e., transmit) through reflective polarizer 28, rather than being reflected. This may, for example, be caused by an interference phase difference decrease in the reflection spectrum of reflective polarizer 28, which shifts the maximum reflection of light rays 22_{S2} to blue-wavelength light and reduces the reflection efficiency of red-wavelength light. As a result, the individual light rays 22_{S2} that leak through reflective polarizer 28 are often red-wavelength light rays. For low F/#s (e.g., less than about F/2.0), orange-wavelength light rays (i.e., from about 580 nanometers to about 600 nanometers) typically also leak through reflective polarizer 28.

Absorptive polarizer 30, however, absorbs the light rays 22_{S2} that leak through reflective polarizer 28, while also transmitting light rays 22_{P2} into output prism 26. As such, absorptive polarizer 30 blocks the non-image-containing light rays that leak through reflective polarizer 28, thereby providing a high contrast for the resulting image, particularly with respect to red-wavelength light rays. Absorptive polarizer 30 is also suitable for blocking light that leaks through reflective polarizer 28 due to cosmetic defects and extinction limitations of the reflective polarizer design, or due to haze, as is described in Ma et al., U.S. Publication No. 2004/0227994.

Furthermore, reflective polarizing films may have mild thicknesses changes between packets, which may also result in light leaks through reflective polarizer 28. Such light leaks are similar to the red-wavelength light leaks discussed above, except that the spectrum spikes produced by thickness changes in the film cause green-wavelength and blue-wavelength light to leak through reflective polarizer 28. Absorptive polarizer 30, however, is also suitable for absorbing light leaks in the green and blue wavelengths, thereby reducing light leaks due to thickness changes in reflective polarizer 28.

The combined use of reflective polarizer 28 and absorptive polarizer 30 allows the light cone of light beam 22 to have a wide range of incident angles while preserving the contrast ratio of the displayed image. This correspondingly allows the light cone of light beam 22 to have low F/#s, which translates to higher light throughputs and efficiencies. Examples of suitable F/#s for system 10 include about F/2.5 or less, with particularly suitable F/#s including about F/2.0 or less, and with even more particularly suitable F/#s including about F/1.5 or less.

Additionally, the use of wide range of incident angles also allows reflective polarizer 28 and absorptive polarizer 30 to be oriented at incident angles other than 45°, where the incident angle is an angle between a central ray of a light cone forming light beam 22 and the normal to reflective polarizer 28 and absorptive polarizer 30. Examples of suitable orientations for reflective polarizer 28 and absorptive polarizer 30 include incident angles with absolute values ranging from about 35° to about 50° relative to a central ray of a light cone forming light beam 22, with particularly suitable orientations including incident angles with absolute values ranging from about 40° to about 45°.

In addition to preserving the contrast ratio of the resulting image, positioning reflective polarizer 28 in front of absorptive polarizer 30 also reduces heat generation in absorptive polarizer 30 due to light absorption. When absorptive polarizers, such as absorptive polarizer 30, absorb light rays having unwanted polarization states, the absorbed light rays generate heat in the absorptive polarizer. This can degrade the dichroic dye in the absorptive polarizer, which reduces the useful life the absorptive polarizer. However, reflective polarizer 28 reflects substantial portions of the light rays having unwanted polarization states away from absorptive polarizer 30. This reduces the amount of light rays absorbed by absorptive polarizer 30, thereby preserving the useful life of absorptive polarizer 30.

### EXAMPLES

The present invention is more particularly described in the following examples that are intended as illustrations only, since numerous modifications and variations within the scope of the present invention will be apparent to those skilled in the art.

### Example 1 and Comparative Examples A and B

Image display systems were prepared for Example 1 and Comparative Examples A and B, where each system included a PBS disposed between an illumination source, a pre-polarizer, an imager, and a display screen. The components of each system were arranged in the same manner as shown in FIG. 1 with the pre-polarizer being positioned between the illumination source and the PBS. The imager included a reflective mirror and a ¼-wave plate with its fast or slow axis aligned with the polarization direction of s-polarized light, thereby simulating a ferroelectric LCoS imager in the dark state. The imager bright state was simulated by rotating the ¼-wave plate to be at an angle of 45° relative to the polarization direction for s-polarized light.

The PBS of Example 1 is the same as PBS 14 (shown in FIG. 1, and discussed above), where the reflective polarizer was a multi-layer optical film manufactured under the trade designation “VIKUITI” T-35 advanced polarizing films (APF) from 3M Company, St. Paul, Minn., and the absorptive polarizer was a high-contrast ratio polarizer commercially available under the trade designation “HLC2-2518” from Sanritz Corporation, Tokyo, Japan.

The PBS of Comparative Example A included the same reflective polarizer as used in the PBS of Example 1, but did not include an absorptive polarizer. The PBS of Comparative Example B included the same reflective polarizer and absorptive polarizer as used in the PBS of Example 1, except that the absorptive polarizer was placed outside of the PBS, adjacent to outer surface 40 in FIG. 1 (i.e., an external clean-up polarizer). The polarizing films of the PBSs of Example 1 and Comparative Examples A and B were each positioned at an incident angle of 45° relative to a central ray of a light cone forming the incident light beam, and the light cones had an F/# of F/2.0.

During the experimentation, a light beam was emitted through each system and the amount of red-wavelength light that leaked through the PBSs was visually observed on the display screen and quantitatively measured. Because a reflective mirror and a ¼-wave plate were used in place of a polarization-rotating imager, the reflected light rays retained the s-polarization state upon reflection. As a result, the light rays reflected from the mirror would reflect from the reflective polarizer back toward the illumination source, thereby providing a dark state image on the display screen.

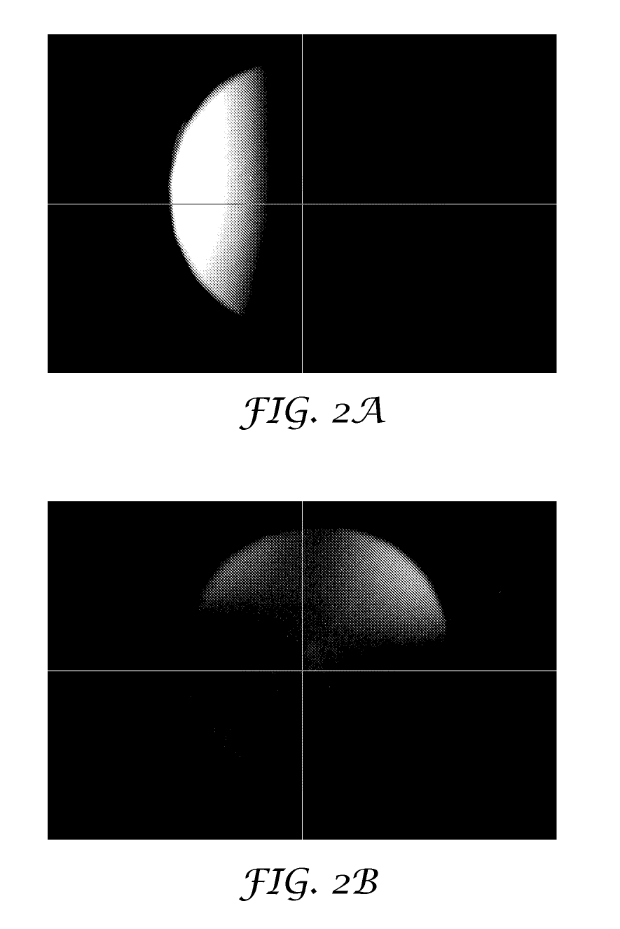

FIG. 2A is a micrograph of a display pupil of the system of Comparative Example A (no absorptive polarizer). As shown, the system of Comparative Example A provided a dark image, with the exception of a red portion (represented by the light-colored portion in FIG. 2A) visually observable on about 40% of the display screen adjacent a lateral edge of the display screen. The red portion corresponded to red-wavelength light rays that intersected the reflective polarizer at high incident angles to the normal of reflective polarizer. The red-wavelength light rays leaked through the reflective polarizer and were projected onto the display screen. In use with a polarization-rotating imager, the leaked light would reduce the contrast ratio of the projected image.

FIG. 2B is a micrograph of a display pupil of the system of Example 1. The systems of Example 1 (internal absorptive polarizer) and Comparative Example B (external absorptive polarizer), however, provided images that were substantially dark, and did not exhibit any visually observable red portions. The images exhibited only mild light leaks at the edges of the display screen, represented by the lighter-colored portion in FIG. 2B. Nonetheless, the absorptive polarizers used in the PBSs of Example 1 and Comparative Example B effectively absorbed the red-wavelength light rays that leaked through the reflective polarizers.

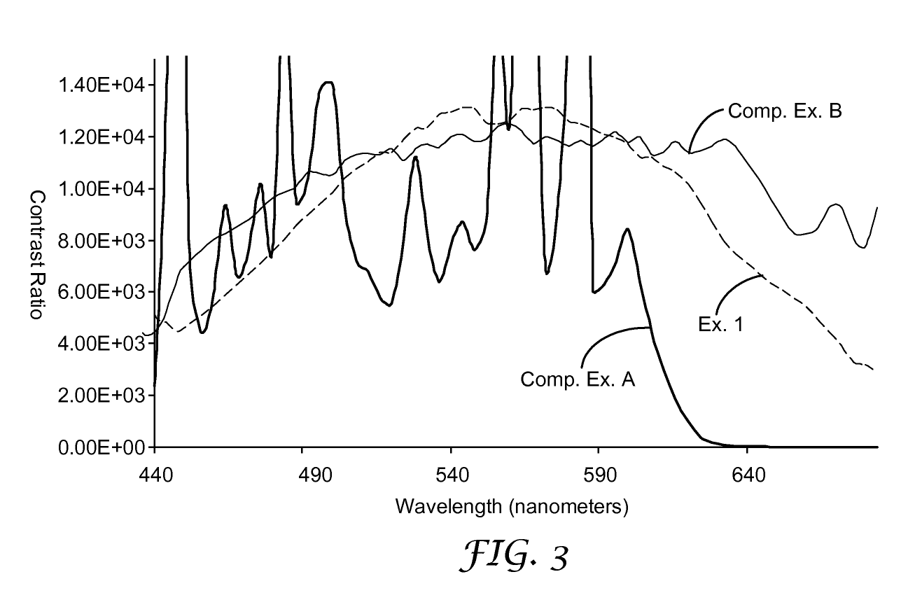

FIG. 3 is a graph representing the measured contrast ratio versus light-wavelength spectrum for the systems of Example 1 and Comparative Examples A and B. A discussion regarding how the contrast ratio is determined is provided in Ma et al., U.S. Publication No. 2004/0227898, the disclosure of which is hereby incorporated by reference herein to the extent it is not inconsistent with the present disclosure. For a given viewing direction, a “contrast ratio” is defined as the ratio of the light intensity of the brightest state and the darkest state capable of being displayed on a screen. Typically, contrast ratio is measured for a specific location on a screen, with the display device driven to brightest state and darkest state on separate occasions. Table 1 provides the measured photopically weighted contrast ratios based on the color wavelengths for the systems of Example 1 and Comparative Examples A and B.

TABLE 1

| | Contrast | Contrast Ratio | Contrast Ratio |
|---|---|---|---|
| Example | Ratio (Red) | (Green) | (Blue) |
| Example 1 | 10728 | 10303 | 8930 |
| Comparative Example A | 180 | 9068 | 10728 |
| Comparative Example B | 11557 | 11769 | 12361 |

The data in FIG. 3 and Table 1 show the high contrast ratios obtained with the PBS of Example 1. In comparison, for red-wavelength light rays, the PBS of Comparative Example A exhibited low contrast ratios due to the leaked red-wavelength light. The contrast ratios obtained for the system of Example 1 are comparable to those obtained for the system of Comparative Example B. However, as discussed above, securing the reflective polarizer and the absorptive polarizer together, prior to placing this combination within the PBS, reduces the risk of misaligning the block axes of the reflective polarizer and the absorptive polarizer during the assembly of system, thereby reducing the complexity of manufacturing system. In comparison, the absorptive polarizer used in Comparative Example B was aligned with reflective polarizer at a location that is external to the PBS. This increased the complexity of manufacturing the system of Comparative Example B.

### Examples 2-4 and Comparative Examples C-E

Image display systems for Examples 2-4 were arranged in the same manner as discussed above for the system for Example 1, except that the polarizing films were oriented at incident angles of 35°, 45° and 60°, respectively, relative to a central ray of a light cone forming the incident light beam (e.g., in Example 2, the incident angle between a central ray of a light cone forming the light beam and the normal to the reflective polarizer and the absorptive polarizer was 35°). Similarly, image display systems for Comparative Examples C-E were arranged in the same manner as discussed above for the system for Comparative Example B (no absorptive polarizer), except that the polarizing films were oriented at incident angles of 35°, 45° and 60°, respectively, relative to a central ray of a light cone forming the incident light beam.

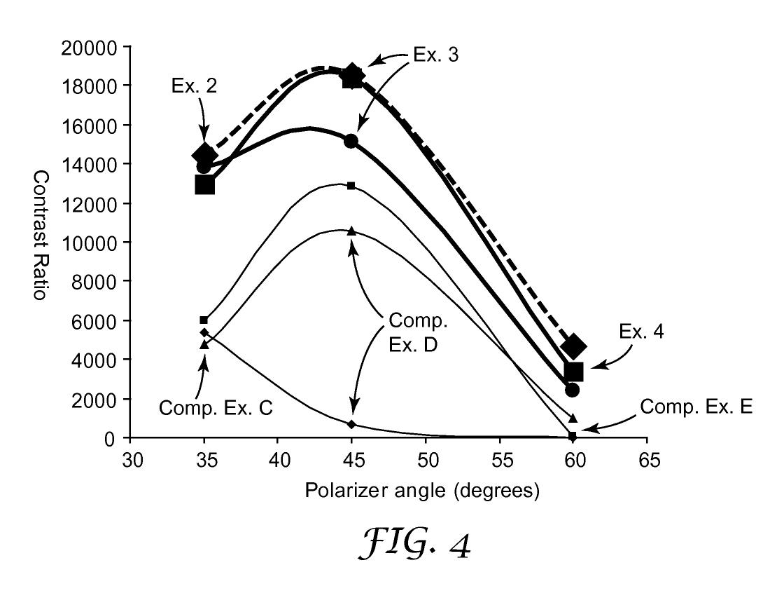

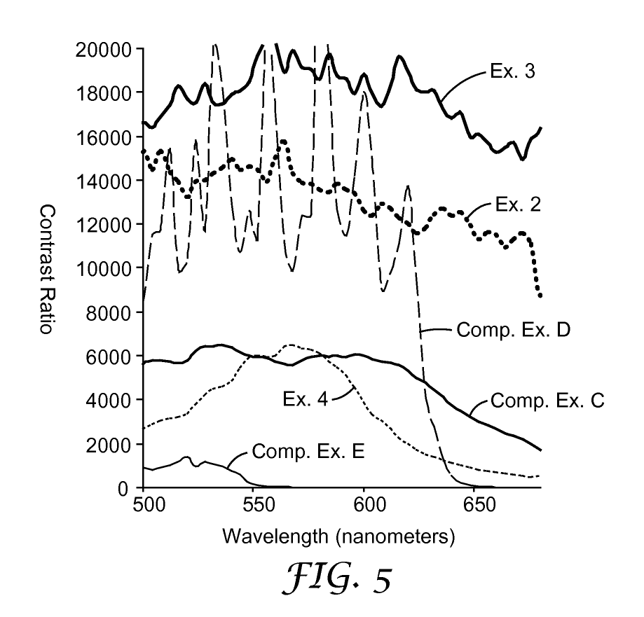

FIGS. 4 and 5 are graphs representing the measured contrast ratio versus the polarizer incident angle and the light-wavelength spectrum, respectively, for the systems of Examples 2-4 and Comparative Examples C-E. Similarly, Table 2 provides the measured contrast ratios based on the color wavelengths for the systems of Examples 2-4 and Comparative Examples A and B.

TABLE 2

| | Contrast | Contrast Ratio | Contrast Ratio |
|---|---|---|---|
| Example | Ratio (Red) | (Green) | (Blue) |
| Example 2 (35 degrees) | 12939 | 14447 | 13802 |
| Example 3 (45 degrees) | 18378 | 18494 | 15116 |
| Example 4 (60 degrees) | 3384 | 4685 | 2431 |
| Comparative | 5359 | 5963 | 4759 |
| Example C (35 degrees) | | | |
| Comparative | 689 | 12861 | 10562 |
| Example D (45 degrees) | | | |
| Comparative | 3 | 67 | 986 |
| Example E (60 degrees) | | | |

The data in FIGS. 3 and 4, and Table 2 show the high contrast ratios obtained with the PBSs of Examples 2-4, particularly in the red-wavelength spectrum. The data also shows how the incident angle of the polarizing films affects the contrast ratio across the entire wavelength spectrum. As discussed above, particularly suitable orientations for the reflective and absorptive polarizers include incident angles ranging from about 40° to about 45°. As shown in FIGS. 3 and 4, and Table 2, these incident angles provide high contrast ratios across the entire visible spectrum.

Although the present invention has been described with reference to preferred embodiments, workers skilled in the art will recognize that changes may be made in form and detail without departing from the spirit and scope of the invention.

1. An image display system comprising:
an illumination source configured to emit a light beam;
a polarizing beam splitter comprising:
a reflective polarizer; and
an absorptive polarizer disposed adjacent the reflective polarizer, wherein the absorptive polarizer is configured to receive a first portion of the light beam that has transmitted through the reflective polarizer; and
an image-forming device disposed to receive a second portion of the light beam that has been reflected by the reflective polarizer.

2. The image display system of claim 1, wherein the reflective polarizer is oriented at an incident angle ranging from about 35° to about 50° relative to a central ray of a light cone forming the light beam.

3. The image display system of claim 1, wherein the image-forming device comprises a reflective image-forming device.

4. The image display system of claim 1, wherein the reflective polarizer is selected from the group consisting of a multi-layer polymer optical film, a polymer blend polarizing film, a wire grid polarizer, a cholesteric polarizer, a fiberglass composite polarizer, and a dielectric thin film coating.

5. The image display system of claim 1, wherein the reflective polarizer and the absorptive polarizer are secured together.

6. The image display system of claim 1, wherein the absorptive polarizer is configured to absorb light wavelengths ranging from about 580 nanometers to about 700 nanometers along a block axis of the absorptive polarizer.

7. The image display system of claim 1, wherein the polarizing beam splitter further comprises a pair of prisms, the reflective polarizer and the absorptive polarizer being disposed between the pair of prisms.

8. The image display system of claim 1, wherein the reflective image-forming device comprises a liquid crystal on silicon device.

9. The image display system of claim 1, wherein the reflective polarizer is characterized by a pass axis and the absorptive polarizer is characterized by a pass axis, and the pass axis of the reflective polarizer is aligned with the pass axis of the absorptive polarizer.

10. An image display system comprising:
an illumination source configured to emit a light beam;
a polarizing beam splitter comprising:
a first prism comprising a first outer surface, a second outer surface, and an incident surface;
a reflective polarizer disposed adjacent the incident surface of the first prism; and
an absorptive polarizer disposed adjacent the reflective polarizer, opposite the first prism, wherein the absorptive polarizer is configured to receive a first portion of the light beam that has transmitted through the reflective polarizer; and
an image-forming device disposed to receive a second portion of the light beam from the reflective polarizer.

11. The image display system of claim 10, wherein the reflective polarizer is oriented at an incident angle ranging from about 35° to about 50° relative to a central ray of a light cone forming the light beam.

12. The image display system of claim 10, wherein the image-forming device comprises a reflective image-forming device.

13. The image display system of claim 10, wherein the reflective polarizer is selected from the group consisting of a multi-layer polymer optical film, a polymer blend polarizing film, a wire grid polarizer, a cholesteric polarizer, a fiberglass composite polarizer, and a dielectric thin film coating.

14. The image display system of claim 10, wherein the polarizing beam splitter further comprises a second prism having an incident surface disposed adjacent the absorptive polarizer, opposite the reflective polarizer.

15. The image display system of claim 10, wherein the absorptive polarizer is configured to absorb light wavelengths ranging from about 580 nanometers to about 700 nanometers along a block axis of the absorptive polarizer.

16. The image display system of claim 10, wherein the reflective image-forming device comprises a liquid crystal on silicon device.

17. The image display system of claim 10, wherein the reflective polarizer is characterized by a pass axis and the absorptive polarizer is characterized by a pass axis, and the pass axis of the reflective polarizer is aligned with the pass axis of the absorptive polarizer.

18. An image display system comprising:
an illumination source configured to emit a light beam;
a polarizing beam splitter comprising:
a reflective polarizer; and
an absorptive polarizer disposed adjacent the reflective polarizer, wherein the absorptive polarizer is configured to absorb light wavelengths ranging from about 580 nanometers to about 700 nanometers along a block axis of the absorptive polarizer; and
an image-forming device disposed to receive at least a portion of the light beam from the reflective polarizer.

19. The image display system of claim 18, wherein the reflective polarizer is oriented at an incident angle ranging from about 35° to about 50° relative to a central ray of a light cone forming the light beam.

20. The image display system of claim 18, wherein the image-forming device comprises a reflective image-forming device.

21. The image display system of claim 18, wherein the reflective polarizer is selected from the group consisting of a multi-layer polymer optical film, a polymer blend polarizing film, a wire grid polarizer, a cholesteric polarizer, a fiberglass composite polarizer, and a dielectric thin film coating.

22. The image display system of claim 18, wherein the reflective image-forming device comprises a liquid crystal on silicon device.

23. The image display system of claim 18, wherein the reflective polarizer is characterized by a pass axis and the absorptive polarizer is characterized by a pass axis, and the pass axis of the reflective polarizer is aligned with the pass axis of the absorptive polarizer.
